(19) United States
(12) Patent Application Publication
(10) Pub. No.: US 2026/0175802 A1
(43) Pub. Date: Jun. 25, 2026

(54) COMMON GROUND COOLANT LOOP SYSTEM FOR ISOLATED POWER NETS

(71) Applicant: Torc Robotics, Inc., Blacksburg, VA (US)

(72) Inventors: Pablo Smith, Spicewood, TX (US); William Gray Davis, Austin, TX (US); Akshay Pai Raikar, Austin, TX (US); Michael Avitabile, Cary, NC (US)

(21) Appl. No.: 18/999,370

(22) Filed: Dec. 23, 2024

(51) Int. Cl. B60R 16/03; B60R 16/08

(52) U.S. Cl. CPC B60R 16/03; B60R 16/08

(57) ABSTRACT

A power system for an autonomous vehicle is disclosed where the power system comprises a first power source, at least one power supply electrically coupled to the first power source, at least one overvoltage protection circuit, and a first conductive fluid subsystem. Each at least one overvoltage protection circuit is electrically coupled between one at least one power supply and the first conductive fluid subsystem. The first conductive fluid subsystem is connected to ground.

### TECHNICAL FIELD

The field of the disclosure relates to the distribution and implementation of a common ground for a distributed power system, and more specifically the field of the disclosure relates to the distribution of a common ground for a power net using a coolant loop.

### BACKGROUND

Power systems and the power electronics associated with the power systems need to be protected from voltage spikes and other over voltages that can occur during their use. Generally, such overvoltage protection is provided by clamping circuits and clamping devices that prevent the power electronics from being subjected to an overvoltage condition produced by a voltage surge. Voltage surges can be caused by the failure of all or a portion of a power system, failure of a device in the power system, or by a lightning strike to the power system. The voltage clamping devices are connected to the power electronics and tied to a common ground.

In order to protect multiple stages of power electronics, a common ground is distributed throughout the electronics so that protection devices may be attached from the various power supplies to the common ground. The common ground is often comprised of a bus bar, typically made from a copper material. The bus bar is distributed throughout the power system. Power system architecture may comprise a fixed volume. The volume houses system power nets, that include associated devices and connections. The power system architecture is densely populated by the associated devices and connections. Therefore, it is difficult to effectively package and fit the ground supplying bus bar in the fixed volume of the power system. Therefore, there is a need to provide a common system ground for the power system power nets that may be effectively and efficiently located within the power system.

### SUMMARY

In one aspect, a power system for an autonomous vehicle is provided. The power system comprises a first power source, at least one power supply electrically coupled to the first power source, at least one first overvoltage protection circuit, and a first conductive fluid subsystem. Each of the at least one first overvoltage protection circuits being electrically coupled between one of the at least one power supply and the first conductive fluid subsystem.

In another aspect, a power system for an autonomous vehicle is provided. The power system comprises a first power source, at least one power supply electrically coupled to the first power source, at least one first overvoltage protection circuit, and a first conductive fluid subsystem, each of the at least one first overvoltage protection circuits is electrically coupled between one of the at least one power supply and the first conductive fluid subsystem. The power system further comprises a second power source, at least one power supply electrically coupled to the second power source, at least one second overvoltage protection circuit, each of the at least one second overvoltage protection circuits being electrically coupled between one of the at least one power supply associated with the second power source and a second conductive fluid subsystem, the first and second conductive fluid subsystems being connected to ground.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of an autonomous vehicle comprising an autonomous truck;

FIG. 2 is a perspective view of an autonomous vehicle comprising an autonomous truck and trailer;

FIG. 3 is a side view of the autonomous truck and trailer of FIG. 2;

FIG. 4 is a block diagram representation of the control technology included in the autonomous vehicle shown in FIG. 1;

FIG. 5 is a schematic representation of an overvoltage protection circuit configured for use in an autonomous vehicle where the overvoltage protection circuit uses a conductive fluid subsystem as a common ground;

FIG. 6 is a schematic representation of an alternate embodiment overvoltage protection circuit configured for use in an autonomous vehicle, where the overvoltage protection circuit uses a conductive fluid subsystem as a common ground;

FIG. 7 is a schematic of a further alternate embodiment overvoltage protection circuit configured for use in an autonomous vehicle where the overvoltage protection circuit uses a first conductive fluid subsystem serving as a first common ground and a second conductive fluid subsystem serving as a second common ground; and

FIG. 8 is an enlarged view of a portion of the coolant conduit of the conductive fluid subsystems on the alternate embodiments of FIGS. 5-7.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below. Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module.

The controller or control module, collectively the “controller technologies” use control theory to determine how to convert desired behaviors and trajectories into actions performed by the autonomous vehicle such as steering, braking and acceleration. To effectively control vehicle actions, the controller technologies require computer processors and sensors to detect and process information, issue commands, and monitor sensors. The electronics require power to operate. The electronics is protected by overvoltage protection circuits that connect power supply outputs to ground through electronic clamping circuits and clamping devices. The clamping devices are connected to ground through a conductive fluid subsystem that comprises conductive fluid conduits that enable the flow of coolant through the autonomous vehicle. The conductive fluid conduits are electrically coupled to ground. In this manner the system for providing power system grounding that extends through the power system, such as an autonomous vehicle power system is effectively and efficiently provided by the conductive fluid conduits.

An autonomous vehicle includes a power system that is specific to the vehicle. The vehicle power system is not supplied with supplemental power from an external power source during vehicle operation. The autonomous vehicle power systems typically comprise discrete power sources such as battery strings which may or may not charge as the vehicle travels along the vehicle's defined path. Each of the power sources are isolated from other power sources, thereby defining a distributed array of power sources. The individual power sources use power supplies to condition the power to a voltage and or current suitable for each set of electronics associated with the discrete power source. Isolated communication networks are used to communicate from one isolated power stage to another isolated power stage. The power supplies are connected to a ground through clamping devices such as metal oxide varistor (MOVs).

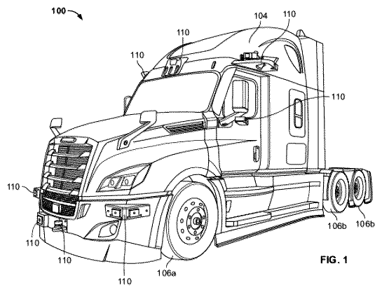

Various embodiments of the overvoltage protection circuit of the present disclosure are described with reference to FIGS. 1-8.

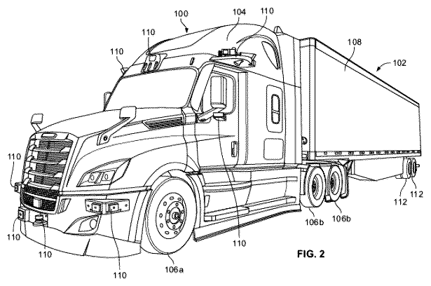

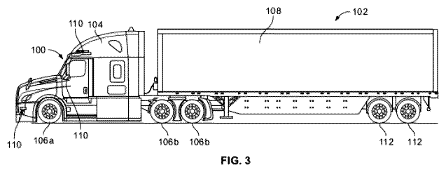

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100, includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

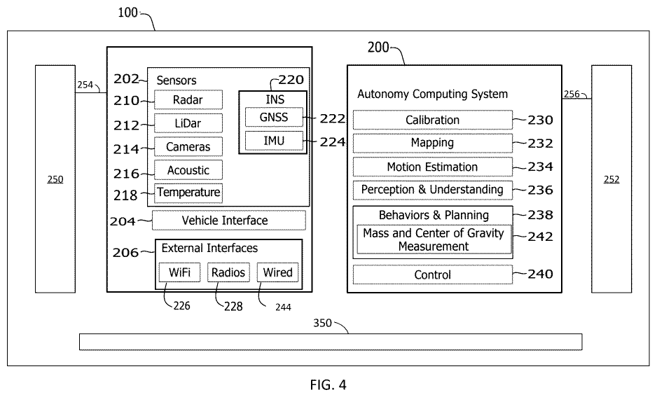

FIG. 4 is a block diagram of the autonomous vehicle shown in FIG. 1. In the example embodiment, autonomous vehicle 100 includes autonomy computing system 200, sensors 202, a vehicle interface 204, and external interfaces 206. The sensors 202, vehicle interface 204, and external interfaces 206 are powered by power source 250 using power bus 254. The autonomy computing system 200 is powered by power source 252 using power bus 256. The electronics is cooled by a conductive fluid system 350 that is electrically coupled to ground. The electronics for the autonomy computing system 200, sensors 202, vehicle interface 204, external interfaces 206, power source 250, power source 252 are located in the cabin 104. The conductive fluid system 350 may be located in the cabin 104 or outside of the cabin.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed and combined to capture the environment surrounding in the environment surrounding autonomous vehicle 100.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

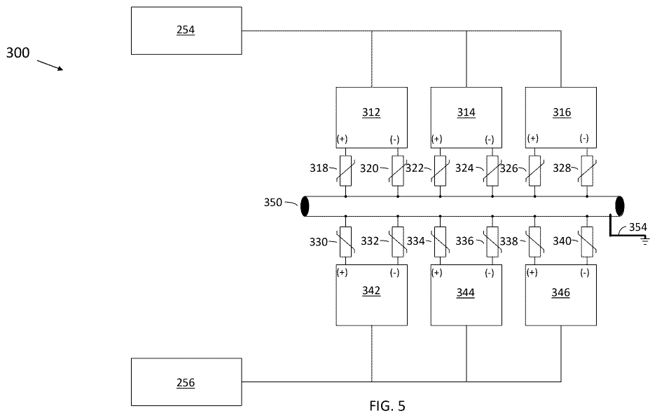

FIG. 5 is a schematic representation of system 300 that includes at least one overvoltage protection circuit of the present disclosure that uses a conductive fluid subsystem as a common ground to efficiently and effectively ground the system 300. The exemplary system 300 is a power distribution system that converts and delivers current that is usable by system electronics used by controller technologies of autonomous vehicle 100. FIG. 5 shows a system 300 that comprises a first power source. In the present embodiment of the disclosure the power source comprises a power bus 254 electrically coupled to a DC power supply 312, a DC power supply 314 and a DC power supply 316. The power supplies may have different voltages such as 5V, 3.3V and 12 V. Each leg of each power supply is electrically coupled to ground 354 through an overvoltage protection circuit and conductive fluid subsystem. The overvoltage circuits are identified in FIGS. 5, 6 and 7 as 318, 320, 322, 324, 326, 328. The conductive fluid subsystem is identified as 350. Each power supply has a plus (+) and a minus (−) connection. A discrete overvoltage circuit is connected to each (+) and each (−) connection. The power bus 254 as disclosed is electrically coupled to three discrete power supplies 312, 314, 316, however, it should be understood that the power bus 254 may be electrically coupled to any required number of discrete power supplies, and is electrically coupled to at least one power supply. Generally, for each power supply utilized, an overvoltage protection circuit is connected between each of the (+) and (−) outputs of each power supply and a terminal of the overvoltage protection circuit. At least one overvoltage circuit is electrically coupled to each power supply.

The plus (+) output of power supply 312 is electrically coupled to a first terminal of overvoltage protection circuit 318. The second terminal of overvoltage protection circuit 318 is electrically coupled to a conductive fluid subsystem 350. The minus (−) connection of power supply 312 is electrically coupled to a first terminal of overvoltage protection circuit 320. The second terminal of overvoltage protection circuit 320 is electrically coupled to the conductive fluid subsystem 350. The conductive fluid subsystem 350 is electrically coupled to ground 354. The conductive fluid subsystem 350 comprises a conduit comprised of a tubular body comprised of a conductive material such as, but not limited to a copper or aluminum material. A fluid, such as antifreeze, ethylene glycol for example, a dielectric coolant, or water flows through the conduit. The fluid that flows through the conduit may also comprise sodium chloride, Graphene or Carbon Nanotube Suspensions, solutions of potassium chloride (KCl), sodium bicarbonate (NaHCO3), or potassium hydroxide (KOH), Gallium-indium-tin alloys (e.g., Galinstan), The conduit is coupled to ground 354.

The plus (+) output of power supply 314 is electrically coupled to a first terminal of overvoltage protection circuit 322. The second terminal of overvoltage protection circuit 322 is electrically coupled to the conductive fluid subsystem 350. The minus (−) connection of power supply 314 is electrically coupled to a first terminal of overvoltage protection circuit 324. The second terminal of overvoltage protection circuit 324 is electrically coupled to the conductive fluid subsystem 350, previously described, and the conductive fluid subsystem 350 is in turn electrically coupled to ground 354.

The plus (+) output of power supply 316 is electrically coupled to a first terminal of overvoltage protection circuit 326. The second terminal of overvoltage protection circuit 326 is electrically coupled to the conductive fluid subsystem 350. The minus (−) connection of power supply 316 is electrically coupled to a first terminal of overvoltage protection circuit 328. The second terminal of overvoltage protection circuit 328 is electrically coupled to the conductive fluid subsystem 350, previously described, and the conductive fluid subsystem 350 is in turn connected to ground 354.

System 300 of FIG. 5 also comprises a second power source which comprises a power bus 256, similar to power bus 254. Power bus 256 is electrically coupled to a DC power supply 342, DC power supply 344 and DC power supply 346. Each leg of each power supply is connected to ground 354 through an overvoltage protection circuit and the conductive fluid subsystem 350. The power supplies 342, 344, and 346 may have different voltages such as 5V, 3.3V and 12 V. The overvoltage circuits are identified in FIGS. 5, 6 and 7 as 330, 332, 334, 336, 338, and 340. Each power supply has a plus (+) and a minus (−) connection. The power bus 256 as disclosed is electrically coupled to three discrete power supplies 342, 344, 346, however, it should be understood that the power bus 256 may be electrically coupled to at least one power supply. Generally, for each power supply utilized, one terminal of a discrete overvoltage protection circuit is connected between each of the (+) and (−) outputs of each power supply and the opposite terminal of each overvoltage protection circuit is electrically coupled to the conductive fluid subsystem 350 which in turn is connected to ground 354. By providing the conductive fluid system 350, the power buses 254 and 256 are able to be effectively connected to ground 354.

The plus (+) output of power supply 342 is electrically coupled to a first terminal of overvoltage protection circuit 330. The second terminal of overvoltage protection circuit 330 is electrically coupled to the conductive fluid subsystem 350. The minus (−) connection of power supply 342 is electrically coupled to a first terminal of overvoltage protection circuit 332. The second terminal of overvoltage protection circuit 332 is electrically coupled to the conductive fluid subsystem 350 previously described, and the conductive fluid subsystem 350 is in turn connected to ground 354.

The plus (+) output of power supply 344 is electrically coupled to a first terminal of overvoltage protection circuit 334. The second terminal of overvoltage protection circuit 334 is electrically coupled to the conductive fluid subsystem 350. The minus (−) connection of power supply 344 is electrically coupled to a first terminal of overvoltage protection circuit 336. The second terminal of overvoltage protection circuit 336 is electrically coupled to the conductive fluid subsystem 350 previously described, and the conductive fluid subsystem 350 is in turn connected to ground 354.

The plus (+) terminal of power supply 346 is electrically coupled to a first terminal of overvoltage protection circuit 338. The second terminal of overvoltage protection circuit 338 is electrically coupled to the conductive fluid subsystem 350. The minus (−) terminal of power supply 346 is electrically coupled to a first terminal of overvoltage protection circuit 340. The second terminal of overvoltage protection circuit 340 is electrically coupled to the conductive fluid subsystem 350 previously described. The conductive fluid subsystem 350 is in turn connected to ground 354.

The conductive fluid conduit of the conductive fluid subsystem 350, is incorporated throughout the power electronics and is used for cooling the system and components. In the embodiments of the present disclosure, the conductive fluid conduit is made of a copper conduit in which a coolant fluid flows. It may be made of other conductive material possessing both the required levels of electrical and thermal conductivity. The coolant fluid can also be comprised of a conductive fluid. The conductive fluid and can comprise water, water with dissolved ions, saltwater, an acidic solution, a glycol-based coolant, a liquid metal, and nano-fluids with nanoparticles.

Voltage surges can occur in the electronics due to component failures system failures and lightning strikes. The overvoltage protection circuits such as previously described circuits 318, 320, 322, 324, 326, 328, 330, 332, 334, 336, 338, and 340 may comprise surge suppressors such as metal oxide varistors (MOV's), a transient voltage suppression diodes (TVS's), or a combination of MOV's and TVS's. A varistor remains non-conductive as a shunt-mode device during normal operation. When the voltage across the device exceeds a maximum voltage usually called the “clamping voltage” the device becomes conductive. When a voltage surge occurs on the output of any of the power supply output terminals such as plus (+) and minus (−) the voltage at the output terminal is limited to the overvoltage protection circuit clamping voltage. In the embodiments, each power supply in FIGS. 5, 6 and 7 is an isolated power supply. Power bus 254 and power bus 256 in the embodiments are also isolated.

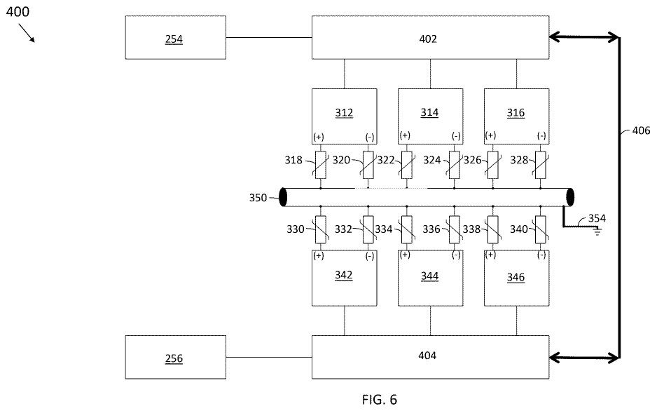

The power system 400 of FIG. 6 is a power distribution circuit, similar to the previously described power system 300. The power system 400 is a power distribution circuit that includes the power sources comprised of power buses 254, 256; power supplies 312, 314, 316, 342, 344, 346; overvoltage protection circuits 318-340; and conductive fluid subsystem 350 as described in conjunction with previously described power system 300. As shown in FIG. 6, the power system 400 also includes power distribution subsystem 402, power distribution subsystem 404, and an isolated communication interface 406. Power distribution subsystem 402 is electrically coupled to power bus 254 and is electrically coupled to power supplies 312, 314, and 316. Power distribution subsystem 404 is electrically coupled to power bus 256 and is electrically coupled to power supplies 342, 344, and 346. The power distribution subsystem 402 communicates with power distribution subsystem 404 via an isolated communication interface 406. The isolated communication interface uses an opto-isolator to maintain its isolation. The isolated communication interface also makes use of a variety of isolators well known to those of ordinary skill in the art. In embodiments, power distribution subsystem 402 and power distribution subsystem 404 are power redundant components. A failure in power distribution subsystem 402 can be communicated to power distribution subsystem 404 so that power distribution subsystem 404 can compensate for the power distribution subsystem 402 failure. Similar system compensation is provided by power distribution subsystem 402 in the event power distribution subsystem 404 fails. Overvoltage protection circuits electrically coupled between power and ground help ensure the viability of the isolated communication interface.

Power distribution subsystem 402 electrically couples the power supplies 312, 314, 316 to the power bus 254. Power distribution subsystem B 404 electrically couples the power supplies 342, 344, 346 to the power bus 256. In the present embodiments, each power distribution subsystem 402 and 404 includes wiring and a bus bar to establish interconnection and also contains sensors, to measure voltages and current and fusible links for circuit protection. The power distribution subsystems 402, 404 in the present embodiments also contain conditioning and control electronics including a processor for fault detection, isolation, and recovery. The overvoltage protection circuits of power system 400 are electrically coupled to the conductive conduit of the conductive fluid subsystem to thereby connect to ground 354 as previously described.

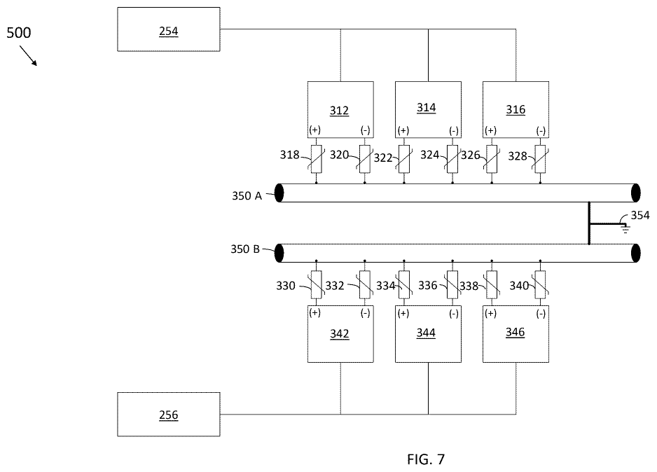

The power system 500 of FIG. 7 is a power distribution circuit, similar to the previously described power system 300. The power system 500 is a power distribution circuit that includes the power sources comprising power buses 254, 256; power supplies 312, 314, 316, 342, 344, 346, overvoltage protection circuits 318-340 and conductive fluid subsystem 350 as described in conjunction with previously described power system 300. However, as shown in FIG. 7, the power system 500 is a power distribution system that comprises respective discrete conductive fluid subsystems 350A, 350B for each power bus 254, 256. Conductive fluid subsystem 350A serves as a common ground for the power supplies and overvoltage circuits that are electrically coupled to power bus 254, and conductive fluid subsystem 350B serves as a common ground for the power supplies and overvoltage circuits that are electrically coupled to power bus 256. Each of the conductive fluid subsystems 350A, 350B are connected to ground 354. Separate conductive fluid subsystems in embodiments are circulated through different portions of the power electronics and each subsystem can be connected to ground and used in the same protective surge configuration of 300 and 400.

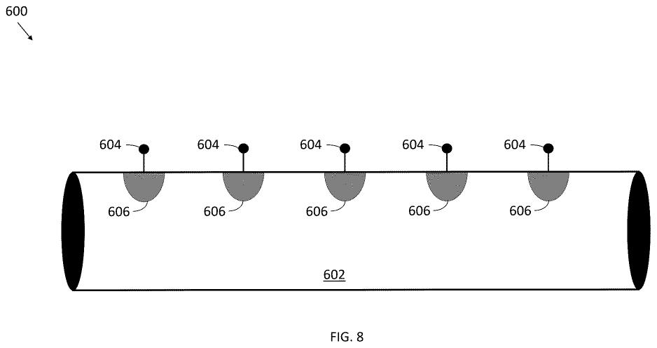

FIG. 8 is an enlarged view of a portion of an alternate embodiment conductive fluid subsystem 600 having conduit 602. The conduit 602 comprises a tubular structure to enable a thermally and electrically conductive fluid to flow there through as previously described in conjunction with conductive fluid subsystem 350. The conduit and subsystem 600 are connected to ground 354 as previously described in conjunction with conductive fluid subsystem 350. In the alternate embodiment the conduit 602 is comprised of a body made from a nonconductive or less than conductive material. For example, the conduit 602 may be comprised of polyvinyl chloride (PVC), high-density polyethylene (HDPE), fiberglass, chlorinated polyvinyl chloride (CPVC), polypropylene, ceramic, rubber, or nylon. The conduit itself defines an interior portion that has a series of discrete conductive islands 606 spaced along the length of the conduit 602. The islands extend through the conduit wall so that conductive portions of each island are provided along the interior and exterior of the conduit 602. The conduit islands may be comprised of any suitable conductive material such as pure silver, pure copper, pure gold, aluminum, zinc, nickel, brass, bronze, iron, platinum, steel, lead, stainless steel. Conductive fluid that flows through the conduit 602 is in contact with these conductive islands. The conductive islands are electrically coupled to a terminal 604 that protrudes through the exterior of the conduit. The terminals 604 are electrically coupled to a discrete overvoltage circuit as described in conjunction with power systems 300, 400 and 500. As a result of the connection of terminal 604 to each island, terminal 604 is coupled to ground so that all of the terminals 604 will in turn couple to ground through the conductive fluid. Making an “ohmic” contact between the conductive islands and the conductive fluid is easily understood of those of ordinary skill in the art.

The conductive fluid subsystems 350, 350A, 350B associated with power systems 300, 400 and 500 serve to efficiently and effectively ground the overvoltage protection circuits during an overvoltage event such as a surge. The ground connections associated with the conductive fluid subsystems provide the effective protection to the power systems.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems is not limiting of the claimed features or this disclosure. Thus, the operation and behavior of the systems were described without reference to the specific software code being understood that software and control hardware can be designed to implement the systems based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The systems described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed systems.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems are not limited to the specific embodiments described herein. Rather, components of the systems or steps may be utilized independently and separately from other described components or steps.

This written description uses examples to disclose various embodiments, which include the best mode, to enable any person skilled in the art to practice those embodiments, including making and using any devices or systems. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A power system for an autonomous vehicle, the power system comprising:
a first power source;
at least one power supply electrically coupled to the first power source;
at least one first overvoltage protection circuit; and
a first conductive fluid subsystem, each at least one first overvoltage protection circuit being electrically coupled between one at least one power supply and the first conductive fluid subsystem.

2. The power system of claim 1, further comprising:
a second power source;
at least one power supply electrically coupled to the second power source; and
at least one second overvoltage protection circuit, each at least one second overvoltage protection circuit being electrically coupled between one at least one power supply associated with the second power source and the first conductive fluid subsystem.

3. The power system of claim 1, wherein:
the first conductive fluid subsystem contains a conductive fluid; and
the conductive fluid is selected from the group consisting of water, water with dissolved ions, saltwater, an acidic solution, a glycol-based coolant, a liquid metal, and nano-fluids with nanoparticles.

4. The power system of claim 1, wherein the first conductive fluid subsystem comprises a conductive conduit configured to enable the flow of a conductive fluid through the conductive conduit.

5. The power system of claim 4, wherein the conductive conduit is made from copper.

6. The power system of claim 1, wherein the first conductive fluid subsystem comprises conduit that is made from a non-conductive material.

7. The power system of claim 6, wherein the conduit comprises a wall, the conduit further comprising at least one conductive island, each at least one island extending through the wall and having portions along the exterior and interior of the conduit, the conduit comprising a terminal electrically coupled to each at least one island.

8. The power system of claim 7 wherein the conduit comprises a plurality of discrete islands spaced along the length of the conduit.

9. The power system of claim 2, wherein:
the power system further comprises a first power distribution subsystem and a second power distribution subsystem;
the first power source is electrically coupled to the first power distribution subsystem;
the first power distribution subsystem is electrically coupled to the first power supply;
the second power source is electrically coupled to the second power distribution subsystem; and
the second power distribution subsystem is electrically coupled to the second power supply.

10. The power system of claim 9, wherein the first power distribution subsystem communicates with the second power distribution subsystem using an isolated communication interface.

11. The power system of claim 1, wherein the first conductive fluid subsystem is connected to ground.

12. The power system of claim 1, wherein:
the first power source is electrically coupled to a first plurality of power supplies;
each of the first plurality of power supplies is electrically coupled to a first terminal of one of the at least one first overvoltage protection circuits; and
the first conductive fluid subsystem is electrically coupled to a second terminal of one of the at least one first overvoltage protection circuits.

13. The power system of claim 1, further comprising:
a second power source;
at least one power supply electrically coupled to the second power source;
at least one second overvoltage protection circuit; and
a second conductive fluid subsystem, each at least one second overvoltage protection circuit being electrically coupled between one at least one power supply associated with the second power source and the second conductive fluid subsystem.

14. A power system for an autonomous vehicle, the power system comprising:
a first power source;
at least one power supply electrically coupled to the first power source;
at least one first overvoltage protection circuit;
a first conductive fluid subsystem, each at least one first overvoltage protection circuit being electrically coupled between one at least one power supply and the first conductive fluid subsystem;
a second power source;
at least one power supply electrically coupled to the second power source;
at least one second overvoltage protection circuit; and
a second conductive fluid subsystem, wherein:
each at least one second overvoltage protection circuit is electrically coupled between one at least one power supply associated with the second power source and the second conductive fluid subsystem; and
the first and second conductive fluid subsystems are connected to ground.

15. The autonomous vehicle power system of claim 14, wherein the first and second conductive fluid subsystems comprise a conduit, the conduit being made from a conductive material.

16. The autonomous vehicle power system of claim 14, wherein the first and second conductive fluid subsystems comprises a conduit, the conduit being made from a non-conductive material.

17. The autonomous vehicle power system of claim 16, wherein the conduit further comprises a plurality of spaced islands along the length of the conduit.

18. The autonomous vehicle power system of claim 16, wherein the conduit is made from a nonconductive material selected from the group consisting of: polyvinyl chloride (PVC), high-density polyethylene (HDPE), fiberglass, chlorinated polyvinyl chloride (CPVC), polypropylene, ceramic, rubber, and nylon.

19. The autonomous vehicle power system of claim 17, wherein the plurality of spaced islands is made of a conductive material selected from the group consisting of: pure silver, pure copper, pure gold, aluminum, zinc, nickel, brass, bronze, iron, platinum, steel, lead, and stainless steel.

20. The autonomous vehicle power system of claim 14, wherein the first and second conductive fluid subsystems contain a conductive fluid that is selected from the group consisting of water, water with dissolved ions, saltwater, an acidic solution, a glycol-based coolant, a liquid metal, and nano-fluids with nanoparticles.
